(19) United States
(12) Patent Application Publication
(10) Pub. No.: US 2014/0270106 A1
(43) Pub. Date: Sep. 18, 2014

(54) METHOD AND SYSTEM FOR INTERACTIVE TELEPHONE WAITING

(71) Applicant: Timothy BARLOW, Chesterfield, VA (US)

(72) Inventor: Timothy BARLOW, Chesterfield, VA (US)

(21) Appl. No.: 13/828,284

(22) Filed: Mar. 14, 2013

(51) Int. Cl. H04M 3/493

(52) U.S. Cl. CPC H04M 3/493
USPC 379/88.01; 709/219

(57) ABSTRACT

A customizable interactive voice response system and method. The customizable interactive voice response system and method can include a menu presented after a phone number associated with an interactive voice response (IVR) system is dialed; an introductory message; a prompt for a personal identification number (PIN); a communication link that transmits and receives data associated with the PIN between the IVR and a remotely located server after a successful PIN entry; and a customized experience presented after the IVR receives data associated with the PIN.

### BACKGROUND

When placing a telephone call to many existing service providers or companies, the use of an automated attendant and menu system is common. Additionally, it is often expected that there will be at least some form of waiting by the calling party before they are able to properly convey any desired information or, more typically, speak directly to a party directly.

During such waiting periods, it is common for the automated system to provide what is commonly known as “hold music”, voice prompts indicating an expected amount of time until the calling party is able to speak directly to another party, information about the service provider or company that the calling party is attempting to speak with or other information that may allow the calling party to communicate with the service provider or company.

Such audio information provided by the automated system may be undesired or lack relevance to the calling party, however. “Hold music,” for example, may not be appreciated by the calling party or may be played at an undesirable volume. Service provider or company information may be irrelevant to the calling party or may cause confusion about how to best communicate with the company. Additionally, any information may be repetitive or counterproductive to the calling party, potentially resulting in dissatisfactory customer service or negative feedback.

### SUMMARY

A customizable interactive voice response system may be described. The customizable interactive voice response system and method can include a menu presented after a phone number associated with an interactive voice response (IVR) system is dialed; an introductory message; a prompt for a personal identification number (PIN); a communication link that transmits and receives data associated with the PIN between the IVR and a remotely located server after a successful PIN entry; and a customized experience presented after the IVR receives data associated with the PIN.

In another exemplary embodiment, a method customizing an interactive voice response system may be described. The method can include logging into a website on a server that is communicatively coupled to an interactive voice response (IVR) system; assigning a personal identification number (PIN) associated with a log in identity; selecting at least one of a plurality of user-changeable menu options; calling a phone number associated with the IVR; entering the PIN on the IVR; transmitting the PIN from the IVR to a remotely located server; determining a successful PIN entry at the remotely located server; and altering available options in the IVR based on data associated with the PIN.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a diagram of an exemplary computer system.

FIG. 2 is a diagram of an exemplary embodiment of a customizable interactive voice response system.

FIG. 3 is an exemplary diagram showing a website associated with a customizable interactive voice response system.

FIG. 4 is an exemplary flow chart showing access and use of a customizable interactive voice response system.

FIG. 5 is an exemplary diagram showing a user login screen associated with a customizable interactive voice response system.

FIG. 6 is a flow chart showing exemplary steps for using a customizable interactive voice response system.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

Generally referring to FIGS. 1-6, a method and system for customizing an interactive voice response system may be described. The method and system may utilize a variety of components that are communicatively coupled at different times in order to present a caller with information or data that is customized or tailored to the desires or specifications of the caller.

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include known methods of data transmission and Internet-related activities. Still other aspects of the invention may utilize wireless data transmission and the like.

In a first exemplary embodiment, and referring now to FIG. 2, a content system 200 for providing desired content to a user may be described. Content system 200 can include a server 202 on which a variety of data may be stored. Server 202 may be communicatively coupled, for example through network connection 206, to any number of computers 204, computing devices or communication devices, such as, but not limited to, smart phones and tablet computers, as well as any other type of computing or communication device. Additionally, server 202 may be communicatively coupled, for example over a network connection 210 to interactive voice response (IVR) system 208.

Server 202 may function in a manner so as to provide and store any of a variety of data. For example, when accessed via network 206, server 202 may provide website content and website access. In such an example, a user at computer 204 may be able to navigate to the website housed on server 202. The user at computer 204 may then be able to view data or gain access to an area of the website that is customized for that user, for example pages providing user-desired content and user-provided information.

Further, IVR 208 may be accessed by a telephone 212 over communication link 214, which may be a public switched telephone network or any other type of communication link. For example, calls may be made over cellular networks, voice-over-IP networks or any other form of network.

As shown in exemplary FIG. 3, website 300 may be associated with server 302 of exemplary FIG. 2. Website 300 may have any desired information shown thereon, as desired. In one example, website 300 may have a variety of fields 302, 304, 306, or other associated webpages that a user may navigate to or otherwise access. For example, field 302 may be populated with user information or data related to a specific user. Such information in field 302 can include a user's name and contact information, username information, password information and any other information or settings that may be desired for a specific user or specific user account. Field 304 may have a variety of user settings. As will be explained in more detail below, the user settings in field 304 may be related to how a user can customize an experience with an IVR, such as IVR 208 shown in exemplary FIG. 2. The settings in field 304 can include, but are not limited to, personal identification number (PIN) settings, IVR-related audio settings, IVR-related volume settings, or any other settings, as desired. Further, field 306 may have any of a variety of user-selected content shown thereon. The content of field 306 can include, but is not limited to, audio data, such as music.

In a further exemplary embodiment, and as shown in exemplary FIG. 4, a method and system for customizing a calling experience or for tailoring an interaction with an IVR may be shown. In this example, a caller may call, in step 402, a phone number associated with a business or service and with whom they desire to speak. In this example, the IVR associated with the business or service may be such that it has an account with server 202 that can allow for individuals to customize or tailor their experience interacting with the IVR. For example, the IVR may allow for user-selected menu options, language options, volume options, hold music options, prompt time options, or any other options that may be associated with an IVR, as desired.

After the caller calls the number associated with the IVR in step 402, the caller may be connected with the IVR in step 404 and provided with an introductory message. Then, in step 406, the caller may be prompted to enter a password or PIN if they have an account with the website associated with server 202 of exemplary FIG. 2. If the caller does not have an account, they may select “NO” in any desired manner, and the IVR can proceed with the execution of standard IVR menus, instructions and commands. If the user does have an account, they may select “YES” and, in step 408, be prompted for a PIN. Upon a satisfactory or correct entering of the password, in step 410, the caller may be provided with menu options that are tailored to both the IVR being called and the caller's choices. Additionally, if the user does not enter an appropriate PIN or enters an incorrect PIN, the user may be returned to a previous prompt, for example the query at step 406.

If the caller has an account and a satisfactory or correct PIN is entered, the IVR may proceed into a user-customized or tailored menu system. In some exemplary embodiments, the menu system may be tailored based upon selections or requests made by the caller, and found on server 202 of exemplary FIG. 2. For example, the IVR may communicate with server 202 through any known or desired communication methodology, for example a network connection. When an acceptable or correct PIN is entered, server 202 may transmit data to the IVR that is associated with the PIN. Thus, the experience that the caller has with the IVR may then be customized through selections made but the caller. Additionally, the IVR may provide standard or desired functionality for the server or company which set up the IVR so as to provide the caller with the appropriate or desired service or information.

In a different exemplary embodiment, the steps shown in FIG. 4 may be substantially replicated when an outgoing call is made to a customer. For example, if a company or service associated with the IVR desires to place an automated call to a customer, the call may be made to the customer's phone number. Then, after an introductory message in 404, the customer may similarly be prompted for a PIN in step 406 if they account with an indicated website or service. In still another exemplary embodiment, if a company or service associated with an IVR desires to call a customer who they are aware of as having set up a customizable IVR experience, a call may be made that essentially begins with step 408 or 410, as desired.

In a further exemplary embodiment, and shown with respect to FIG. 5, a customizable IVR experience may be made by a user. In this exemplary embodiment, a user may access an appropriate website 502 and interface 504 on a computer, or any other desired computing or communication device. Interface 504 may be such that a user can log in through known manners of entering a username and password, or providing any other identifying information. After logging in, interface 504 may provide any desired information or any desired fields which a user may edit, populate or otherwise fill. As stated previously, the user may have an opportunity to input information or data related specifically to them. Additionally, a PIN assigned to the user may be displayed. As in the above exemplary embodiment, the PIN may be used by the user when interacting with an IVR system.

Additionally, a user may edit any number of desired settings commonly associated with IVRs using website 502 and interface 504. For example, a user may select a desired language for the IVR, for example English or Spanish. Next, the user can select a desired volume for the IVR to communicate to the user. This can be adjusted up or down, to any level that may be acceptable for both an IVR and a communication device, such as a telephone, on which the user is communicating with the IVR. The user may be able to further edit the speed at which the IVR communicates, preferences for menu options on the IVR or any other aspect of the IVR that may be tailored to enhance a user's experience with the IVR. For example, a user may be able to select a hot key or hot code that, when dialed on a telephone, immediately puts the user in a queue for speaking with an operator or live person. Additionally, a user may be able to select a desired background noise or other voice or dialing options.

In still another exemplary embodiment, a user may select any of a variety of options using interface 504 to customize their experience while on hold on an IVR. For example, if the user desired to speak to a live person, there is often a wait time. During this wait time, a user may have preselected any of a variety of music choices which may be played. Such music may be played on repeat, at random, in a desired order, or in any other fashion, as desired. Thus, as the user is waiting on hold on the IVR, their music selections can be played. Alternatively, a user may have the ability to select any other desired sound option when they are on hold. For example, an ambient noise sound option may be selected, a “rainforest” sound may be played, a “water” sound may be played, or the user may choose the option to have no sound played whatsoever, as desired. Further, as in the above example, a user may enable a hot key or code that can allow them to change from one type of background noise to another. For example, a user may be listening to music while on hold, but may desire to change the sound option to an ambient noise. Thus, the user could press an appropriate hot key or combination of keys, such as pressing “6” and then “7” on the keypad of their phone, to switch the background noise. Additionally, any other key or combination of keys could be set to give the user controls over other aspects of the background noise. For example, pressing “7” and then “8” may allow a user to skip from one song to the next. Or, alternatively, pressing “8” and then “9” may allow the user to change other music options, for example to repeat a song, change a playlist or order of songs, or perform any other operation related to music, as desired.

In a further exemplary embodiment, any information entered into website 502 may be shared with the company or service associated with the IVR. Thus, the company or service may use the data entered to help tailor their IVR system based on common needs or requests of users, which are reflected in any customized settings of individuals.

Thus, in one example, and as shown in exemplary FIG. 6, when a user successfully enters their PIN in an appropriately-enabled IVR system in step 602, the IVR system may proceed into the user-customized IVR experience. In this example, the IVR system can then proceed to provide the user with the appropriate menu options in step 604. Such menu options may be to get more information about a user's account with the company or service associated with the IVR system, make a payment to the company or service associated with the IVR system, or speak to an operator or live person. The options presented in step 604 may be tailored to the desires of the user, however, and may be provided at a desired volume, in a desired language, at a desired speed and according to any other user-customizable features set by the user. After the user selects the appropriate option, they may, in step 606, be prompted with some options to proceed, such as directly providing information gathered about the user or the user's account, or to speak to an operator. At 608, the user may be given the requested information and then prompted to determine if they have received all of the desired information. If the user has received the desired information, the call may end at 610.

However, if the user selects an option, such as speaking to an operator or live person, in step 606, the user may be placed on hold. In such an example, after the user makes the selection in step 606, the user may then be placed on hold and in a queue to speak with the next available person in step 612. At this time, the user, the user-customizable IVR experience may be enjoyed, as any appropriate sounds or music, as selected by the user, are provided and played to the user. When, in step 614, the user is connected to an operator, the call may proceed in any known manner until it completes and, as in 610, the call ends.

In further exemplary embodiments, it is known that during traditional holding times, for example during step 612, the IVR can provide further information about the company or service associated with the IVR, provide information related to an expected hold time, provide information on alternative manners of contacting the company or service associated with the IVR, provide advertising information, or provide any other information. In the user-customizable IVR experience described herein, such information may still be provided through the IVR at 612, at the discretion of the IVR provider or as needed. In some exemplary embodiments, a user may have the ability to cancel or turn off any additional notifications from the IVR. In another exemplary embodiment, the user may have the ability to have only certain types of information provided, such as notifications of estimated remaining wait time. In other exemplary embodiments, the user may have the ability to enable a hot key or keys which, when pressed, prompt the IVR to provide an estimated wait time. In still other exemplary embodiments, the IVR may allow for certain types of adjustment or canceling of certain notifications or advertisements only upon the purchasing of a subscription or payment of a fee.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A customizable interactive voice response system, comprising:
a menu presented after a phone number associated with an interactive voice response (IVR) system is dialed;
an introductory message;
a prompt for a personal identification number (PIN);
a communication link that transmits and receives data associated with the PIN between the IVR and a remotely located server after a successful PIN entry;
a website associated with the remotely located server that allows for input of data associated with the PIN; and
a customized experience presented after the IVR receives data associated with the PIN.

2. The customizable interactive voice response system of claim 1, wherein the customized experience comprises predetermined hold music.

3. The customizable interactive voice response system of claim 2, wherein the predetermined hold music is one of a predetermined song and a predetermined play list.

4. The customizable interactive voice response system of claim 1, wherein the PIN is set by a user at a computing device remotely located from the server.

5. The customizable interactive voice response system of claim 1, wherein the customized experience comprises at least one of predetermined language options, volume options, and data options associated with the PIN.

6. The customizable interactive voice response system of claim 1, wherein the customized experience comprises utilizing hot keys associated with predetermined tasks.

7. A method of customizing an interactive voice response system, comprising:
logging into a website on a server that is communicatively coupled to an interactive voice response (IVR) system;
assigning, via the website, a personal identification number (PIN) associated with a log in identity;
selecting, via the website, at least one of a plurality of user-changeable menu options;
entering, via the website, data associated with the PIN;
communicating with the IVR;
entering the PIN on the IVR;
transmitting the PIN from the IVR to a remotely located server;
determining a successful PIN entry at the remotely located server; and
altering available options in the IVR based on data associated with the PIN.

8. The method of customizing an interactive voice response system of claim 7, wherein the options are at least one of hold music, IVR language, IVR volume, and IVR menus.

9. The method of customizing an interactive voice response system of claim 7, wherein the communication with the IVR is initiated by a user associated with the PIN.

10. The method of customizing an interactive voice response system of claim 7, wherein the communication with the IVR is initiated by an entity associated with the IVR.

11. The customizable interactive voice response system of claim 1, wherein the website has a user interface comprising:
a user information field;
a user settings field; and
a user-selected content field.

12. The customizable interactive voice response system of claim 11, wherein the the user information field comprises:
a user's name;
a user's contact information;
username information; and
password information.

13. The customizable interactive voice response system of claim 11, wherein the the user settings field comprises:
PIN settings;
IVR-related audio settings; and
IVR-related volume settings.

14. The customizable interactive voice response system of claim 11, wherein the the user-selected content field comprises audio data.
